(19) United States
(12) Patent Application Publication
(10) Pub. No.: US 2024/0401559 A1
(43) Pub. Date: Dec. 5, 2024

(54) Fairing System for a Vertical Axis Wind Turbine

(71) Applicant: Wind Harvest International Inc, Davis, CA (US)

(72) Inventors: Antonio Ojeda Monge, El Puerto de Santa Maria (ES); Omar Garcia, Amarillo, TX (US); Jeff Willis, Omaha, NE (US); David J. Malcolm, Kirkland, WA (US); Olamide Ajala-Inyang, Brentwood, CA (US); Alin-Ionut Munteanu, Leuven (BE)

(73) Assignee: Wind Harvest International Inc, Davis, CA (US)

(21) Appl. No.: 18/329,025

(22) Filed: Jun. 5, 2023

(51) Int. Cl. F03D 1/06; F03D 3/00

(52) U.S. Cl. CPC F03D 1/0675; F03D 3/005

(57) ABSTRACT

A fairing system configured to be attached to an arm of a vertical axis wind turbine is disclosed. The fairing system may include a first fairing portion and a second fairing portion. The first fairing portion may have a semi-elliptical cross section and the second fairing portion may have a V-shaped cross section. The first fairing portion may include a first elongated edge and a second elongated edge, and the second fairing portion may include a third elongated edge and a fourth elongated edge. The first elongated edge may be configured to be connected to the third elongated edge and the second elongated edge may be configured to be connected to the fourth elongated edge to form an aerodynamic structure.

### TECHNICAL FIELD

The present disclosure relates to a fairing system for a vertical axis wind turbine, and more specifically to a two-piece fairing system configured to connect to an arm of a vertical axis wind turbine.

### BACKGROUND

Wind turbines use air flow or wind to generate energy. Wind drives rotation of turbine blades, and turbine generators convert blade kinetic energy into electric power. In a vertical axis wind turbine, a blade is connected to a mast via one or more arms, and the mast is connected to a turbine generator that converts the blade kinetic energy to electric power. While wind is essential for turbine operation, aerodynamic drag may affect turbine efficiency. For example, aerodynamic drag due to arms may reduce turbine efficiency, which is undesirable.

Fairings are typically mounted on the arms to provide aerodynamic structure to the arms. Conventional fairings are difficult to manufacture and attach to the arms, and hence cause inconvenience to contractors installing the wind turbine.

Thus, there is a need for a fairing system that may be easy to manufacture and attach to a wind turbine arm.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a fairing system attached to an arm in accordance with the present disclosure.

FIG. 2 depicts an exploded view of the fairing system and the arm in accordance with the present disclosure.

FIG. 3 depicts a fairing portion attached to the arm in accordance with the present disclosure.

FIG. 4 depicts a blade attached to the arm with the fairing system in accordance with the present disclosure.

FIG. 5 depicts an example arm in accordance with the present disclosure.

FIG. 6 depicts a flow diagram of a method for attaching a fairing system to an arm in accordance with the present disclosure.

### DETAILED DESCRIPTION

### Overview

The present disclosure is directed to a two-piece fairing system configured to be attached to an arm of a vertical axis wind turbine. The fairing system may enhance arm aerodynamic profile when the fairing system may be attached to (or “enclose”) the arm. The fairing system may include a first fairing portion (or a first fairing piece) and a second fairing portion (or a second fairing piece). The first fairing portion may have a semi-elliptical cross section, and may be formed by bending an elongated metal sheet along a first fairing portion length. The second fairing portion may include a first curved wall and a second curved wall that may be connected to each other to form a V-shaped cross section. The first and second fairing portions may form an aerodynamic fairing system, when the first and second fairing portions may be attached to each other on the arm.

The first and second faring portions may be hollow. Further, in some aspects, the arm may also be hollow and may have a rectangular cross section. The arm may include an upper arm wall and a lower arm wall. The first and second fairing portions may have respective upper and lower edges that may connect with upper and lower arm walls via fasteners such as rivet nuts, thereby securing the first and second fairing portions on the arm. In other aspects, the arms may have C-shaped cross section.

The present disclosure discloses a two-piece fairing system for an arm of a vertical axis wind turbine. The fairing system is easy to manufacture and install on the arm. For example, the first fairing portion may be easily manufactured by bending an elongated metal sheet to form a semi-elliptical cross section. Further, the fairing system may be easily installed on the arm by attaching respective edges of the first and second fairing portions to upper and lower arm walls of the hollow and rectangular cross-sectioned arm.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

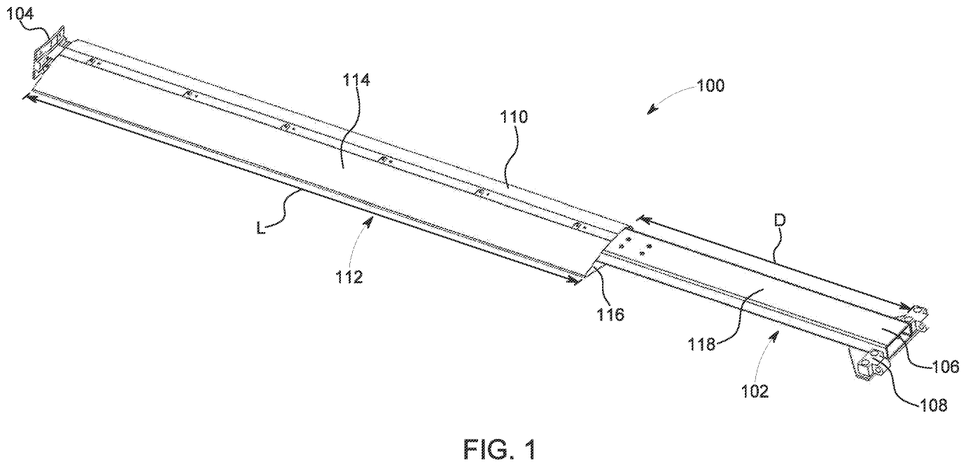

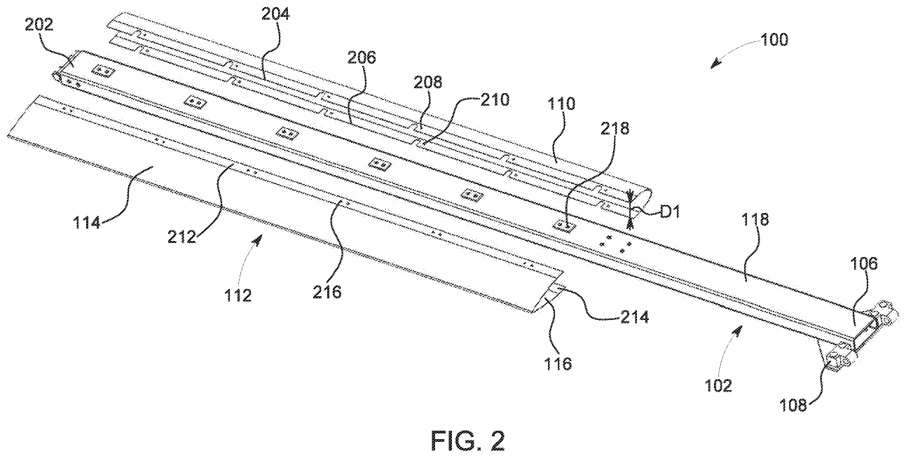

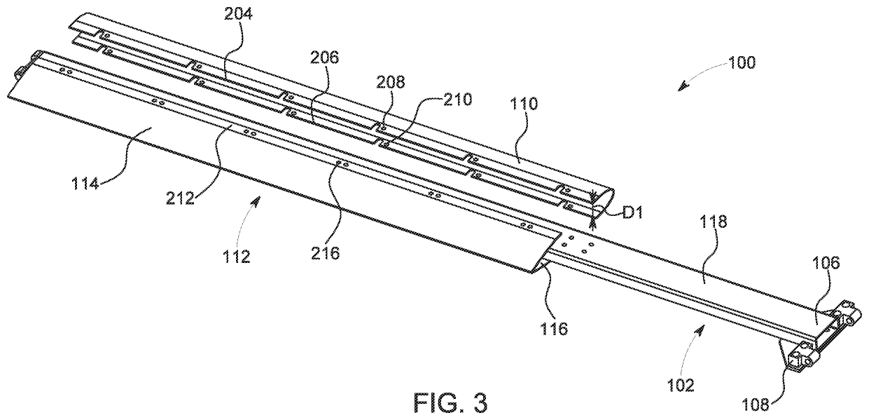

FIG. 1 depicts a fairing system 100 attached to an arm 102 in accordance with the present disclosure. While describing FIG. 1, references may be made to FIGS. 2 and 3. FIG. 2 depicts an exploded view of the fairing system 100 and the arm 102, and FIG. 3 depicts a fairing portion of the fairing system 100 attached to the arm 102.

In some aspects, the fairing system 100 and the arm 102 may be part of a vertical axis wind turbine. A person ordinarily skilled in the art may appreciate that the vertical axis wind turbine may include additional units (not shown) including, but not limited to, turbine blades, a mast, a power generator, and/or the like. In an exemplary aspect, an arm distal end 202 (shown in FIG. 2) may be attached to a blade (not shown in FIGS. 1-3) via a first connection member 104 and an arm proximal end 106 may be attached to a mast (not shown) via a second connection member 108. The first connection member 104 and the second connection member 108 may be pinned or hinged connectors. During turbine operation, winds may exert force on the turbines blades, which may cause the turbine blades to rotate axially relative to a mast longitudinal axis. The turbine blades, which are connected to the arms 102, may cause the mast to rotate when the turbine blades rotate. A mast bottom end may be attached to a drive shaft that may be connected directly or through a gearbox to a power generator that may be configured to generate electric power when the mast rotates. Specifically, the power generator may convert mast kinetic energy into electric energy, thus generating electric power from the vertical axis wind turbine.

The fairing system 100 may be mounted or attached to the arm 102 to improve arm aerodynamic profile. The arm 102 may be made of metal such as aluminum, iron, steel, lightweight alloy, and/or the like. The arm 102 may have dimensions that may depend on one or more parameters including, but not limited to, wind turbine dimensions, location of geographical area where the wind turbine may be located, desired electric power output from the wind turbine, and/or the like. The arm 102 may be of any shape, e.g., cuboidal having rectangular, square, etc. cross-sectional profile, cylindrical having circular, oval or C-shaped cross-sectional profile, etc. Further, the arm 102 may be hollow or solid. Although FIGS. 1-3 depict the arm 102 as being a hollow cuboid with rectangular cross-section, the present disclosure is not limited to such an arm structure, and the arm 102 may have any other structure without departing from the present disclosure scope.

The fairing system 100 may have a length “L” that may be equivalent to or less than an arm length (as shown in FIG. 1). In some aspects, the fairing system 100 may be attached to the arm 102 such that a fairing system distal end may be disposed over the arm distal end 202, and a fairing system proximal end may be disposed at a predefined distance “D” from the arm proximal end 106, as shown in FIG. 1. The distance “D” may depend on the wind turbine dimensions.

The fairing system 100 may include a first fairing portion 110 and a second fairing portion 112. The first and second fairing portions 110, 112 may be made of same material as the arm 102 and/or other wind turbine units (e.g., blades, mast, etc.). The first and second fairing portions 110, 112 may have elongated shapes and may have equivalent lengths “L” (i.e., fairing system length).

The first fairing portion 110 may have a semi-elliptical or semi-oval cross-section, as shown in FIGS. 2 and 3. Specifically, the first fairing portion 110 may be an elongated metal sheet that may be bent along the length “L” by a contractor in a manufacturing plant/shop to form the semi or full elliptical cross sectional shape. A person ordinarily skilled in the art may appreciate that forming the first fairing portion 110 by bending the metal sheet into the final shape requires the manufacturing process of the faring system 100 use a specially made die of that aerodynamic shape. This makes it easier to assemble the fairing system 100. A standard roller die can be used to make a semi-elliptical shape where the fairing first portion 110 is hand pressed into its final shape during the assembly process.

The second fairing portion 112 may have a V-shaped cross section, as shown in FIGS. 1-3. Specifically, the second fairing portion 112 may include a first curved wall 114 and a second curved wall 116 that may be connected to each other along the length “L” to form the V-shaped cross section. In some aspects, the first and second curved walls 114, 116 may form a unitary structure of the second fairing portion 112.

The first and second fairing portions 110, 112 may be hollow and may be configured to attach to (and enclose) a portion of the arm 102 to improve arm aerodynamic profile. In some aspects, the first fairing portion 110 may include a first elongated edge 204 and a second elongated edge 206, as shown in FIG. 2. The first and second elongated edges 204, 206 may be disposed along the entire length “L”. Further, the first and second elongated edges 204, 206 may be disposed at a predefined distance “D1” from each other, as shown in FIG. 2. In some aspects, the distance “D1” can be wider as the fairing first portion 110 may be pressed into the final shape in the assembly process.

The first fairing portion 110 may further include a first set of attachment mechanism 208 disposed in proximity to (or on) the first elongated edge 204 and a second set of attachment mechanism 210 disposed in proximity to (or on) the second elongated edge 206. The first and second sets of attachment mechanisms 208, 210 may include one or more attachment mechanisms that may be disposed along an entire first fairing portion length, and each attachment mechanism may be equidistant from adjacent attachment mechanisms, as shown in FIG. 2. Further, a count of attachment mechanisms in the first set of attachment mechanism 208 may be same as a count of attachment mechanisms in the second set of attachment mechanism 210.

The first and second sets of attachment mechanisms 208, 210 may be similar to each other and may include through-holes, U-shaped (or any other shaped) recesses, or any other attachment means that may enable the first fairing portion 110 to attach to one or more units (e.g., the arm 102) via fasteners, e.g., rivet nuts, bolts, etc. Stated another way, the first fairing portion 110 may be attached to the arm 102 via the first and second sets of attachment mechanisms 208, 210 and the fasteners such as rivet nuts (not shown). Attachment between the first fairing portion 110 and the arm 102 is described later in the description below in conjunction with FIG. 3.

The second fairing portion 112 may include a third elongated edge 212 and a fourth elongated edge 214, as shown in FIG. 2. The third and fourth elongated edges 212, 214 may be disposed along the entire length “L”. Further, the third and fourth elongated edges 212, 214 may be disposed at the same predefined distance “D1” from each other as the distance between the first and second elongated edges 204, 206.

The second fairing portion 112 may further include a third set of attachment mechanism 216 disposed in proximity to (or on) the third elongated edge 212 and a fourth set of attachment mechanism (not shown) disposed in proximity to (or on) the fourth elongated edge 214. The third and fourth sets of attachment mechanisms may be similar to the first and second sets of attachment mechanisms 208, 210, and may enable the second fairing portion 112 to be attached to one or more units (e.g., the arm 102) by using the fasteners described above. The third and fourth sets of attachment mechanisms may include one or more attachment mechanisms that may be disposed along an entire second fairing portion length, and each attachment mechanism may be equidistant from adjacent attachment mechanisms, as shown in FIG. 2. Further, a count of attachment mechanisms in the third set of attachment mechanism 216 may be same as a count of attachment mechanisms in the fourth set of attachment mechanism. Furthermore, the attachment mechanisms in the third and fourth sets of attachment mechanisms may be aligned in positions relative to the attachment mechanisms in the first and second sets of attachment mechanisms 208, 210.

In some aspects, the first and second fairing portions 110, 112 may form an aerodynamic structure (e.g., the fairing system structure shown in FIG. 1) when the first elongated edge 204 may be connected (e.g., on the arm 102) to the third elongated edge 212, and the second elongated edge 206 may be connected (e.g., on the arm 102) to the fourth elongated edge 214. Attachment of the first and second fairing portions 110, 112 to the arm 102 is described below.

In some aspects, the arm 102 may have a rectangular cross-section as shown in FIGS. 1-3. Further, in the exemplary aspect depicted in FIGS. 1-3, the arm 102 is hollow. As described above, the arm 102 may have any cross-sectional shape (e.g., rectangular, square, circular, etc.) and may be hollow or solid. A hollow and rectangular cross-sectional arm shown in FIGS. 1-3 is only for illustrative purpose and should not be construed as limiting the present disclosure scope.

The hollow and rectangular cross-sectional arm 102 may include an upper wall 118 and a lower arm (not shown) disposed opposite to the upper wall 118. The upper wall 118 may include a first set of arm attachment mechanism 218 disposed on the upper wall 118 along an entire arm length or along a portion of the arm length, as shown in FIG. 2. Similarly, the lower wall may include a second set of arm attachment mechanism (not shown) disposed on the lower wall along the entire arm length or along a portion of the arm length.

In some aspects, each attachment mechanism of the first and second sets of arm attachment mechanisms may be equidistant from adjacent attachment mechanisms. Further, a count of attachment mechanisms in the first set of arm attachment mechanism 218 may be equivalent to a count of attachment mechanisms in the first and third sets of attachment mechanisms 208, 216. Similarly, a count of attachment mechanisms in the second set of arm attachment mechanism may be equivalent to a count of attachment mechanisms in the second and fourth sets of attachment mechanisms.

The first and second sets of arm attachment mechanisms may be through-holes disposed on the upper wall 118 and the lower wall respectively, which may enable the arm 102 to be attached to the first and second fairing portions 110, 112 via fasteners such as rivet nuts. For example, to attach the fairing system 100 to the arm 102, a contractor may first “insert” the second fairing portion 112 into an arm edge (e.g., a left edge) via the third and fourth elongated edges 212, 214, as shown in FIG. 3. Specifically, the third elongated edge 212 may be disposed over the upper wall 118, such that the third set of attachment mechanism 216 may be overlaid over the first set of arm attachment mechanism 218. Similarly, the fourth elongated edge 214 may be disposed over the lower wall such the fourth set of attachment mechanism may be overlaid over the second set of arm attachment mechanism.

Responsive to inserting the second fairing portion 112 in the arm left edge, the contractor may insert the first fairing portion 110 into the opposing arm edge (e.g., a right edge) via the first and second elongated edges 204, 206 to form the aerodynamic structure of the fairing system 100, as shown in FIG. 1. The first fairing portion 110 may be inserted such that the first elongated edge 204 may be disposed over the upper wall 118 and the first set of attachment mechanism 208 may be overlaid over the first set of arm attachment mechanism 218. Similarly, the second elongated edge 206 may be disposed over the lower wall such that the second set of attachment mechanism 210 may be overlaid over the second set of arm attachment mechanism.

When the first and second fairing portions 110, 112 enclose the arm 102 as shown in FIG. 1, the contractor may attach the first and second fairing portions 110, 112 to the arm 102 by using fasteners such as rivet nuts. Specifically, the contractor may use rivet nuts to attach the first set of arm attachment mechanism 218 with the first set of attachment mechanism 208, thereby attaching the first elongated edge 204 to the first set of arm attachment mechanism 218 (and hence to the upper wall 118). Similarly, the contractor may use rivet nuts to attach the first set of arm attachment mechanism 218 with the third set of attachment mechanism 216, thereby attaching the third elongated edge 212 to the first set of arm attachment mechanism 218 (and hence to the upper wall 118).

In a similar manner, the contractor may use rivet nuts to attach the second set of arm attachment mechanism with the second set of attachment mechanism 210, thereby attaching the second elongated edge 206 to the second set of arm attachment mechanism (and hence to arm lower wall). The contractor may additionally use rivet nuts to attach the second set of arm attachment mechanism with the fourth set of attachment mechanism, thereby attaching the fourth elongated edge 214 to the second set of arm attachment mechanism (and hence to the arm lower wall).

When the first and second fairing portions 110, 112 may be securely attached to the arm 102 as described above, the fairing system 100 may improve the arm aerodynamic profile. Since the first and second fairing portions 110, 112 are attached to the arm upper wall 118 and the lower wall (and not through the entire arm body), attaching the fairing system 100 to the arm 102 is easier than attaching a conventional fairing system (e.g., to a solid arm). Further, the arm 102 does not bend when the first and second fairing portions 110, 112 may be attached to the upper wall 118 and the arm lower wall.

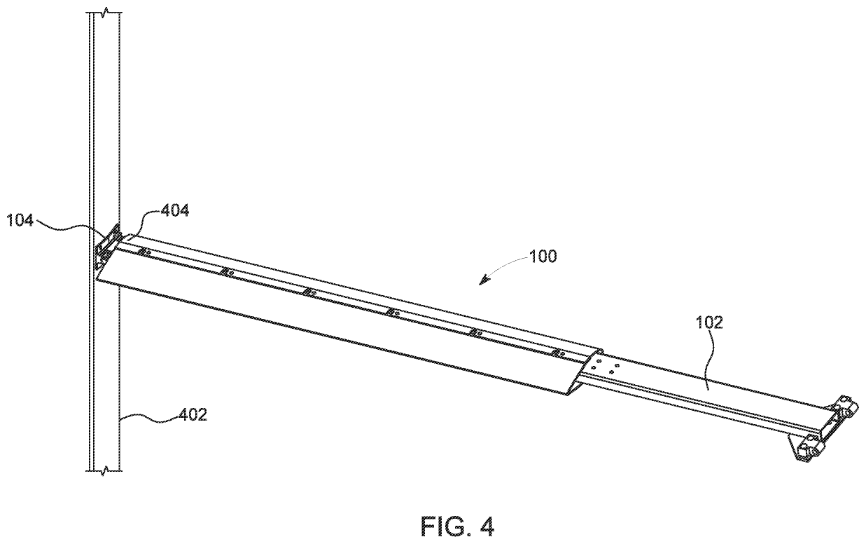

FIG. 4 depicts a blade 402 attached to the arm 102 with the fairing system 100 in accordance with the present disclosure. In some aspects, the blade 402 may be attached to the arm 102 via the first connection member 104, which may be a pinned connection member enabling flexible blade-arm connection. The fairing system 100 may attached to the arm 102 such that a fairing system distal end 404 may be disposed in proximity to the blade 402. A transition fairing (not shown) may be further attached over the first connection member 104 to enhance aerodynamic profile of the blade-arm connection.

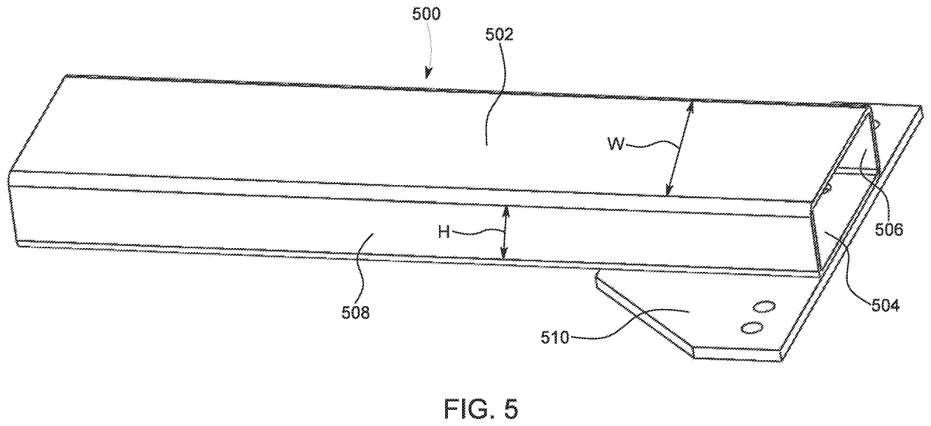

FIG. 5 depicts an example arm 500 in accordance with the present disclosure. The arm 500 may be same as the arm 102. Specifically, FIG. 5 depicts an enlarged view of a hollow arm 500 with a rectangular cross-section. The arm 500 may include four rectangular plates attached to each other to form the rectangular cross-section.

The arm 500 may include an upper wall 502 (or upper rectangular plate), a lower wall 504, a right side wall 506 and a left side wall 508. The dimensions of each wall may depend on the wind turbine dimensions. In an exemplary aspect, the upper and lower walls 502, 504 may have width “W” in a range of 200-300 mm, and the right and left side walls 506, 508 may have height “H” in a range of 70-130 mm. Further, arm wall thickness may be in range of 6-10 mm.

Arm profile, as described above, makes the arm 500 lightweight, and thus the arm 500 experiences less drag. Further, hollow rectangular cross-section enables the contractor to conveniently attach one or more units (e.g., a hinge plate 510, as shown in FIG. 5, or the fairing system 100 described above) to one or more arm walls (e.g., the lower wall 504, as shown in FIG. 5), thus enhancing ease of installation of the wind turbine.

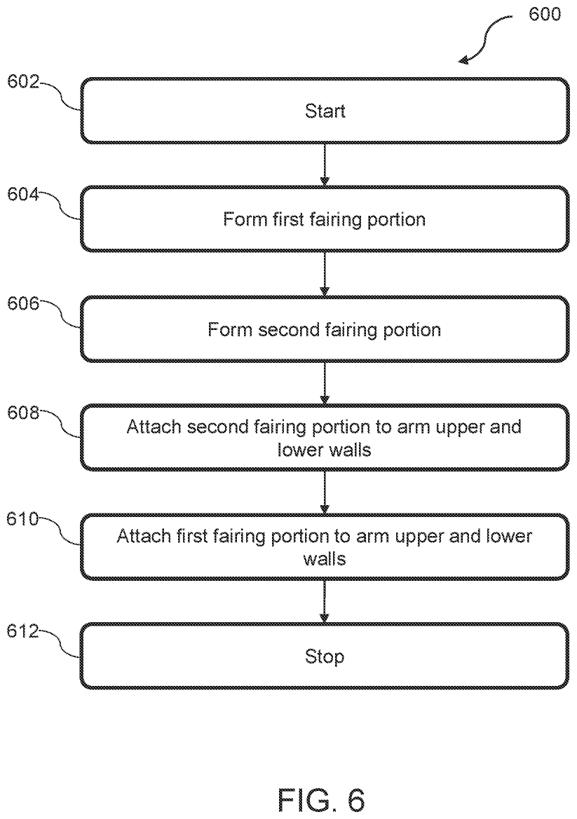

FIG. 6 depicts a flow diagram of a method 600 for attaching the fairing system 100 to the arm 102 in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

The method 600 starts at step 602. At step 604, the method 600 may include forming the first fairing portion 110. As described above, the contractor (or a robot) may form the first fairing portion 110 by bending an elongated metal sheet along the length “L”. At step 606, the method 600 may include forming the second fairing portion 112. The contractor (or a robot) may form the second fairing portion 112 may bending an elongated metal sheet along the length “L” to form V-shaped cross section, or by attaching the first curved wall 114 and the second curved wall 116 along the length “L” to form the V-shaped cross section.

At step 608, the method 600 may include attaching the second fairing portion 112 to the upper wall 118 and the arm lower wall by using the rivet nuts, as described above. At step 610, the method 600 may include attaching the first fairing portion 110 to the upper wall 118 and the arm lower wall by using the rivet nuts, as described above.

The method 600 ends at step 612.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A fairing system comprising:
a first fairing portion having a semi-elliptical cross section, wherein the first fairing portion comprises a first elongated edge and a second elongated edge;
a second fairing portion having a V-shaped cross section, wherein the second fairing portion comprises a third elongated edge and a fourth elongated edge, and
wherein the first elongated edge is configured to be connected to the third elongated edge and the second elongated edge is configured to be connected to the fourth elongated edge to form an aerodynamic structure,
a first set of attachment mechanism disposed in proximity to the first elongated edge and a second set of attachment mechanism disposed in proximity to the second elongated edge; and
a third set of attachment mechanism disposed in proximity to the third elongated edge and a fourth set of attachment mechanism disposed in proximity to the fourth elongated edge;
wherein:
the first set of attachment mechanism, the second set of attachment mechanism, the third set of attachment mechanism, and the fourth set of attachment mechanism comprise first through-holes or “U-shaped” recess, and configured to attach the first fairing portion and the second fairing portion to an arm of a wind turbine,
the arm comprises a distal end and a proximal end, the distal end is attached to a blade of the wind turbine and the proximal end is attached to a mast of the wind turbine;
the arm is a cuboidal-shaped arm having an upper wall and a lower wall, wherein the upper wall comprises a first arm attachment mechanism and the lower wall comprises a second arm attachment mechanism, wherein the first arm attachment mechanism and the second arm attachment mechanism comprise second through-holes,
the first elongated edge is configured to attach to the upper wall of the cuboidal-shaped arm via the first set of attachment mechanism and the first arm attachment mechanism,
the third elongated edge is configured to attach to the upper wall of the cuboidal-shaped arm via the third set of attachment mechanism and the first arm attachment mechanism,
the second elongated edge is configured to attach to the lower wall of the cuboidal-shaped arm via the second set of attachment mechanism and the second arm attachment mechanism, and
the fourth elongated edge is configured to attach to the lower wall of the cuboidal-shaped arm via the fourth set of attachment mechanism and the second arm attachment mechanism.

2. The fairing system of claim 1, wherein the second fairing portion comprises a first curved wall and a second curved wall connected with each other to form the V-shaped cross section.

3. The fairing system of claim 2, wherein the first curved wall and the second curved wall form a unitary structure of the second fairing portion.

4. The fairing system of claim 1, wherein the first elongated edge and the second elongated edge are disposed at a predefined distance from each other, and wherein the third elongated edge and the fourth elongated edge are disposed at the predefined distance from each other.

5. The fairing system of claim 1, wherein the first fairing portion and the second fairing portion are hollow.

6. The fairing system of claim 1, wherein the first fairing portion is an elongated metal sheet bent to form the semi-elliptical cross section.

7.-11. (canceled)

12. The fairing system of claim 1, wherein the arm is hollow.

13. The fairing system of claim 1, wherein the arm is solid.

14. A fairing system comprising:
a first fairing portion having a semi-elliptical cross section, wherein:
the first fairing portion is an elongated metal sheet bent to form the semi-elliptical cross section, and
the first fairing portion comprises a first elongated edge and a second elongated edge;
a second fairing portion comprising a first curved wall and a second curved wall connected with each other to form a V-shaped cross section, wherein the second fairing portion comprises a third elongated edge and a fourth elongated edge, and
wherein the first elongated edge is configured to be connected to the third elongated edge and the second elongated edge is configured to be connected to the fourth elongated edge to form an aerodynamic structure,
a first set of attachment mechanism disposed in proximity to the first elongated edge and a second set of attachment mechanism disposed in proximity to the second elongated edge; and
a third set of attachment mechanism disposed in proximity to the third elongated edge and a fourth set of attachment mechanism disposed in proximity to the fourth elongated edge;
wherein:
the first set of attachment mechanism, the second set of attachment mechanism, the third set of attachment mechanism, and the fourth set of attachment mechanism comprise first through-holes or “U-shaped” recess, and configured to attach the first fairing portion and second fairing portion to an arm of a wind turbine,
the arm comprises a distal end and a proximal end, the distal end is attached to a blade of the wind turbine and the proximal end is attached to a mast of the wind turbine;
the arm is a cuboidal-shaped arm having an upper wall and a lower wall, wherein the upper wall comprises a first arm attachment mechanism and the lower wall comprises a second arm attachment mechanism, wherein the first arm attachment mechanism and the second arm attachment mechanism comprise second through-holes,
the first elongated edge is configured to attach to the upper wall of the cuboidal-shaped arm via the first set of attachment mechanism and the first arm attachment mechanism,
the third elongated edge is configured to attach to the upper wall of the cuboidal-shaped arm via the third set of attachment mechanism and the first arm attachment mechanism,
the second elongated edge is configured to attach to the lower wall of the cuboidal-shaped arm via the second set of attachment mechanism and the second arm attachment mechanism, and
the fourth elongated edge is configured to attach to the lower wall of the cuboidal-shaped arm via the fourth set of attachment mechanism and the second arm attachment mechanism.

15. The fairing system of claim 14, wherein the first curved wall and the second curved wall form a unitary structure of the second fairing portion.

16. The fairing system of claim 14, wherein the first fairing portion and the second fairing portion are hollow.

17.-19. (canceled)

20. A vertical axis wind turbine comprising:
an arm comprising an upper wall and a lower wall; and
a fairing system having a first fairing portion and a second fairing portion, wherein:
the first fairing portion has a semi-elliptical cross section,
the first fairing portion comprises a first elongated edge and a second elongated edge,
the second fairing portion has a V-shaped cross section,
the second fairing portion comprises a third elongated edge and a fourth elongated edge,
wherein the first elongated edge and the third elongated edge are configured to be attached to the upper wall, and wherein the second elongated edge and the fourth elongated edge are configured to be attached to the lower wall,
a first set of attachment mechanism disposed in proximity to the first elongated edge and a second set of attachment mechanism disposed in proximity to the second elongated edge; and
a third set of attachment mechanism disposed in proximity to the third elongated edge and a fourth set of attachment mechanism disposed in proximity to the fourth elongated edge; wherein:
the first set of attachment mechanism, the second set of attachment mechanism, the third set of attachment mechanism, and the fourth set of attachment mechanism comprise first through-holes or “U-shaped” recess, and configured to attach the first fairing portion and second fairing portion to the arm,
the arm comprises a distal end and a proximal end, the distal end is attached to a blade of the vertical axis wind turbine and the proximal end is attached to a mast of the vertical axis wind turbine;
the arm is a cuboidal-shaped arm, wherein the upper wall comprises a first arm attachment mechanism and the lower wall comprises a second arm attachment mechanism, wherein the first arm attachment mechanism and the second arm attachment mechanism comprise second through-holes,
the first elongated edge is configured to attach to the upper wall via the first set of attachment mechanism and the first arm attachment mechanism,
the third elongated edge is configured to attach to the upper wall via the third set of attachment mechanism and the first arm attachment mechanism,
the second elongated edge is configured to attach to the lower wall via the second set of attachment mechanism and the second arm attachment mechanism, and
the fourth elongated edge is configured to attach to the lower wall via the fourth set of attachment mechanism and the second arm attachment mechanism.

21. The fairing system of claim 1, wherein the second through-holes overlay the first through-holes or “U-shaped” recess to attach the first fairing portion and the second fairing portion to the arm.

22. (canceled)

23. (canceled)

24. The fairing system of claim 1, wherein:
the first through-holes associated with the first elongated edge overlay with the first through-holes associated with the third elongated edge and the second through-holes associated with the upper wall of the cuboidal-shaped arm, and
the first through-holes associated with the second elongated edge overlay with the first through-holes associated with the fourth elongated edge and the second through-holes associated with the lower wall of the cuboidal-shaped arm to connect the first fairing portion and the second fairing portion with the cuboidal-shaped arm.

25. The fairing system of claim 1, wherein:
a count of the first through-holes or “U-shaped” recess associated with the first set of attachment mechanism and the third set of attachment mechanism is equivalent to a count of the second through-holes associated with the first arm attachment mechanism, and
a count of the first through-holes or “U-shaped” recess associated with the second set of attachment mechanism and the fourth set of attachment mechanism is equivalent to a count of the second through-holes associated with the second arm attachment mechanism.
